(19) United States
(12) Patent Application Publication
(10) Pub. No.: US 2013/0074027 A1
(43) Pub. Date: Mar. 21, 2013

(54) DESIGNING DEVICE FOR SEMICONDUCTOR INTEGRATED CIRCUIT AND DESIGNING METHOD FOR SEMICONDUCTOR INTEGRATED CIRCUIT

(71) Applicant: Kazunari KIMURA, Kanagawa (JP)

(72) Inventor: Kazunari KIMURA, Kanagawa (JP)

(73) Assignee: KABUSHIKI KAISHA TOSHIBA, Tokyo (JP)

(21) Appl. No.: 13/422,236

(22) Filed: Mar. 16, 2012

(30) Foreign Application Priority Data
Sep. 21, 2011 (JP) 2011-206395

(51) Int. Cl. G06F 17/50

(52) U.S. Cl. 716/119

(57) ABSTRACT

A designing device for a semiconductor integrated circuit of an embodiment includes a low-order hierarchy wiring design portion configured to design a first wiring; and a high-order hierarchy wiring design portion configured to design a second wiring. The low-order hierarchy wiring design portion divides the first functional block into a plurality of small regions, calculates a number of wiring layers required for wiring in the functional block for each of the plurality of small regions and sets the number as the number of low-order hierarchy wiring layers, sets wiring layers in the number of the low-order hierarchy wiring layers from the wiring layer located on the lowermost part as a low-order hierarchy wiring region for each of the plurality of small regions, and places the first wiring in the low-order hierarchy wiring region.

### CROSS-REFERENCE TO RELATED APPLICATION

This application is based upon and claims the benefit of priority from the Japanese Patent Application No. 2011-206395, filed on Sep. 21, 2011; the entire contents of which are incorporated herein by reference.

### FIELD

An embodiment described herein relates generally to a designing device for a semiconductor integrated circuit and a designing method for a semiconductor integrated circuit.

### BACKGROUND

In the prior-art designing of a semiconductor integrated circuit, a plurality of cells, which are already-designed basic circuits including a logical circuit such as an AND circuit and an OR circuit, a flip-flop circuit, a memory circuit and the like, are placed at predetermined regions in a chip, and respective signal connections are wired so as to realize a desired function. In recent years, more functions can be mounted on one chip owing to improvement in semiconductor manufacturing technology, and a mounting gate scale has increased. With such advances, importance of designing including placement of the cells, wiring and the like in a chip has been raised.

Thus, as a designing method for a large-scale semiconductor integrated circuit, a hierarchical designing method has often been used in which the placement of cells and installation of wiring are performed for each of a plurality of functional blocks, and then, a layout is designed by using each of them as one semiconductor integrated circuit. In the prior-art wiring design, wiring of a high-order hierarchy is designed after the wiring of a low-order hierarchy is designed. In general, the wiring layer where wiring is installed is composed of a plurality of layers both in the low-order hierarchy and the high-order hierarchy. In the wiring design of the low-order hierarchy, the wiring is installed by using all the layers of the plurality of wiring layers for whole surfaces of the functional blocks constituting the low-order hierarchy. On the other hand, in the wiring design of the high-order hierarchy, when wiring is installed between the functional blocks constituting the high-order hierarchy, the wiring is installed by setting the whole surfaces on the functional blocks constituting the low-order hierarchy as a wiring prohibited area. That is, the wiring between the functional blocks has been installed by using a peripheral part between the functional blocks.

However, with the above-described prior-art wiring design, with higher integration of the semiconductor integrated circuit and spread of multifunctional system chips such as SoC (System on Chip), the number of functional blocks mounted on one chip increases and the wiring between the functional blocks becomes complicated. Thus, there is a problem that an area of a peripheral region required for the wiring increases, and as a result, the chip size also increases.

### BRIEF DESCRIPTION OF THE DRAWINGS

FIG. 1 is a diagram for explaining an example of a designing device for a semiconductor integrated circuit according to the embodiment.

FIG. 2 is a flowchart for explaining a processing procedure of a design program 31.

FIG. 3 is a flowchart for explaining a designing procedure of a low-order hierarchy of the semiconductor integrated circuit in the embodiment.

FIG. 4 is a diagram for explaining an example of a plan view of a functional block 4 in the low-order hierarchy divided into small regions 4a.

FIG. 5 is a diagram for explaining an example of distribution of wiring density in the functional block 4.

FIG. 6 is a diagram for explaining a number of required wiring layers Lₙ of each small region 4a.

FIG. 7 is a diagram for explaining a wiring prohibited layer Lᵣᵣ of each small region 4a.

FIG. 8 is a flowchart for explaining a designing procedure of a high-order hierarchy of the semiconductor integrated circuit in the embodiment.

FIG. 9 is a layout of a chip 5 on which functional blocks 6a and 6b of the high-order hierarchy and the functional block 4 of the low-order hierarchy are placed.

FIGS. 10A and 10B are diagrams for explaining a wiring prohibited region Rᵣᵤ set on the functional block 4 of the low-order hierarchy during wiring of the high-order hierarchy.

FIG. 11 is a plan view for explaining an example of placement layout of wirings 7a to 7c which connects the functional blocks of the high-order hierarchy to each other.

FIG. 12 is a diagram for explaining an example of distribution of the wiring density in the functional block 4 and the number of required wiring layers Lₙ in each of regions d1 to d4.

FIG. 13 is a diagram for explaining a wiring prohibited layer Lᵣᵣ in each of the regions d1 to d4 illustrated in FIG. 12.

### DETAILED DESCRIPTION

A designing device for a semiconductor integrated circuit in an embodiment includes a low-order hierarchy wiring design portion configured to design a first wiring which connects a plurality of cells placed in a first functional block of a low-order hierarchy composed of the first functional block having wiring layers laminated in plural and a high-order hierarchy wiring design portion configured to design a second wiring which connects second functional blocks of a high-order hierarchy provided with a plurality of second functional blocks, each having the wiring layers laminated in plural. The low-order hierarchy wiring design portion divides the first functional block into a plurality of small regions, calculates a number of the wiring layers required for wiring in the functional block for each of the plurality of small regions and sets the number as the number of low-order hierarchy wiring layers, sets the wiring layers in the number of the low-order hierarchy wiring layers from the wiring layer located on a lowermost part as a low-order hierarchy wiring region for each of the plurality of small regions, and places the first wiring in the low-order hierarchy wiring region. The high-order hierarchy wiring design portion places the second wiring in the wiring layer of the first functional block other than the low-order hierarchy wiring region.

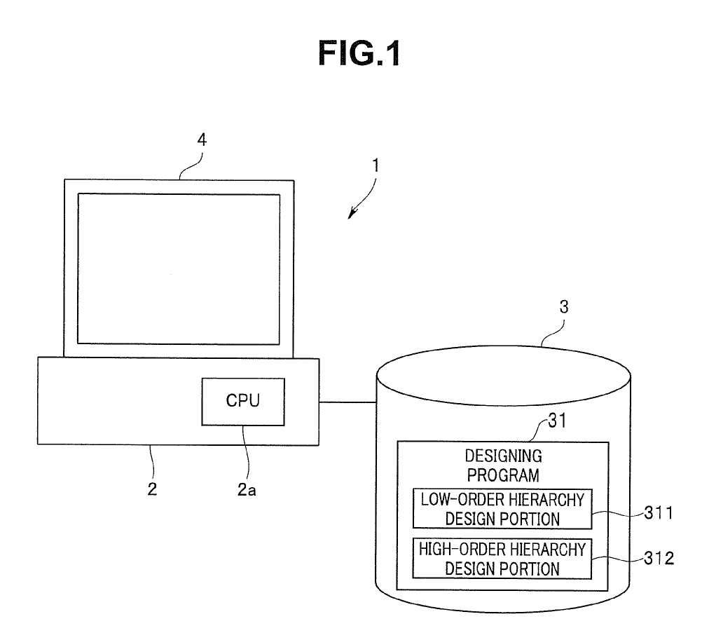

The embodiment will be described by referring to the attached drawings. First, a configuration of the designing device for a semiconductor integrated circuit of this embodiment will be described by referring to FIG. 1. FIG. 1 is a diagram for explaining an example of the configuration of the designing device for a semiconductor integrated circuit according to this embodiment.

The designing device 1 for a semiconductor integrated circuit includes a main device 2 having a central processing unit (hereinafter referred to as a CPU) 2a which executes various software programs, a storage portion 3 which is connected to the main device 2 and stores the various software programs and the like, and a display portion 4 connected to the main device 2. Though not shown, an input device such as a keyboard, a mouse and the like through which a user gives an instruction to have the various programs executed is connected to the main device 2.

The storage portion 3 stores a design program 31 which designs a semiconductor integrated circuit or particularly designs wiring as one of the various software programs. The design program 31 is composed of a low-order hierarchy design portion 311 configured to design a low-order hierarchy of the semiconductor integrated circuit and a high-order hierarchy design portion 312 configured to design a high-order hierarchy. The CPU 2a of the main device 2 can execute or read out the programs and the like stored in the storage portion 3.

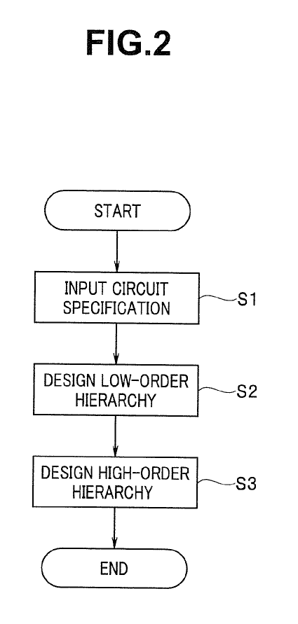

A processing procedure of the design program 31 will be described by using FIG. 2. FIG. 2 is a flowchart for explaining the processing procedure of the design program 31. First, at Step S1, a logical circuit specification of the semiconductor integrated circuit is inputted. Subsequently, at Step S2, placement of the cells in the functional block of the low-order hierarchy and wiring are executed in the low-order hierarchy design portion 311 on the basis of the inputted circuit specification. Then, the routine proceeds to Step S3, the placement of the functional blocks of the high-order hierarchy and wiring are executed in the high-order hierarchy design portion 312 on the basis of the circuit specification and design information of the low-order hierarchy, and the design of the entire semiconductor integrated circuit is finished.

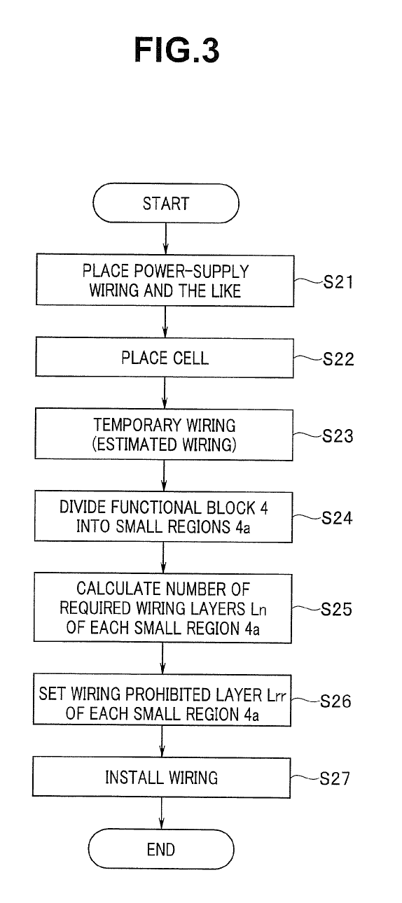

A detailed procedure of the low-order hierarchy design at Step S2 will be described by using FIG. 3. FIG. 3 is a flowchart for explaining the designing procedure of the low-order hierarchy of the semiconductor integrated circuit in this embodiment. First, at Step S21, a signal line required to be placed fixedly such as a power-supply wiring is placed. Subsequently, the routine proceeds to Step S22, and circuit information of the semiconductor integrated circuit to be designed, which is described in advance in a net list or the like, is read out. A plurality of cells, which are basic circuits including a logical circuit such as an AND circuit and an OR circuit, a flip-flop circuit, a memory circuit and the like, are placed at predetermined regions in the functional block 4 of the low-order hierarchy, which is a first functional block, in accordance with a designing rule prescribed in a design rule.

Subsequently, the routine proceeds to Step S23, and connection information of the semiconductor integrated circuit to be designed, which is described in advance in the net list or the like, is read out. Temporary wiring (estimated wiring) is placed between the cells placed in the functional block 4 at Step S22 on the basis of the connection information.

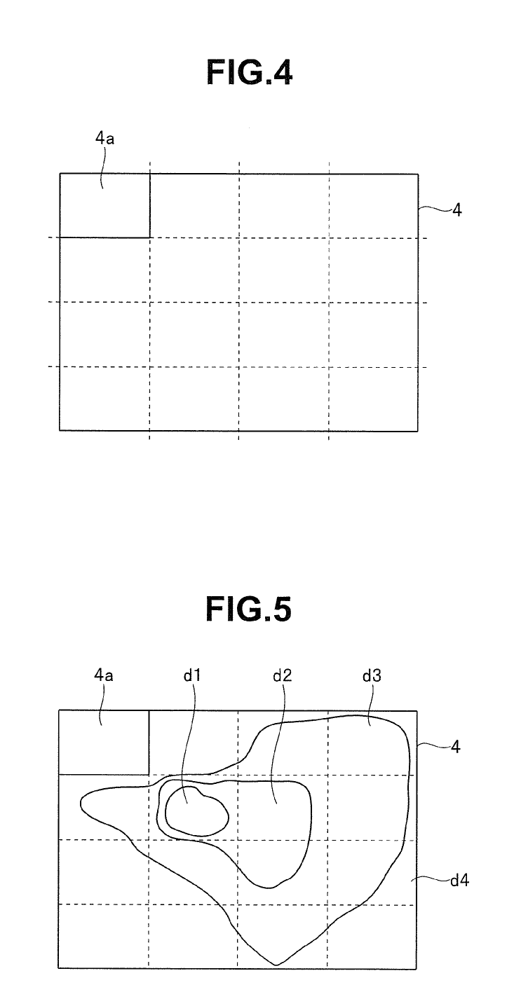

Subsequently, the functional block 4 of the low-order hierarchy is divided into small regions 4a (Step S24). FIG. 4 illustrates an example of a plan view of the functional block 4 of the low-order hierarchy divided into the small regions 4a. In the example illustrated in FIG. 4, each side of the functional block 4 of the low-order hierarchy having a substantially rectangular planar shape when the semiconductor integrated circuit is seen from the upper face is equally divided into 4 parts, respectively, that is, into the 4×4=16 small regions 4a (hereinafter if each of the 16 small regions 4a needs to be particularly identified, a row number and a column number where the small region 4a is located are given to the reference numeral as suffixes. For example, the small region 4a located at the uppermost left part, which is the first row and the first column in the functional block 4 is described as the small region 4a₁₁. That is, the functional block 4 is divided into 16 small regions 4a, which are, 4a₁₁, 4a₁₂, 4a₁₃, 4a₁₄, 4a₂₁, 4a₂₂, 4a₂₃, 4a₂₄, 4a₃₁, 4a₃₂, 4a₃₃, 4a₃₄, 4a₄₁, 4a₄₂, 4a₄₃, 4a₄₄.).

Subsequently, the routine proceeds to Step S25, and a number of required wiring layers Lₙ is calculated for each of the small regions 4a. The number of required wiring layers Lₙ is the total number of the wiring layers required minimally for the installation of the wiring in order to prevent malfunction of the functional block 4. The functional block 4 is composed of six wiring layers, for example, over the whole regions. The wiring density hardly becomes uniform in all the regions of the functional block 4, and a region where the number of wirings is large and the wiring is closely placed and a region where the number of wirings is small and the wiring is scarcely placed are present depending on a spot. In the region with the larger number of wirings, the wiring needs to be placed in a three-dimensional manner by using many wiring layers in order to prevent short-circuit between the wirings which causes malfunction. On the other hand, in the region with the smaller number of wirings, a distance between the wirings can be sufficiently ensured even with fewer wiring layers. That is, the number of required wiring layers Lₙ becomes large in the region with high wiring density, while the number of required wiring layers Lₙ becomes small in the region with low wiring density.

As described above, the number of required wiring layers Lₙ is calculated by calculating the wiring density. The wiring density is calculated as the rate of temporary wirings placed at Step S23 to the number of wirings that can be theoretically installed. FIG. 5 illustrates an example of a calculation result of the wiring density. FIG. 5 is a diagram for explaining an example of distribution of the wiring density in the functional block 4. As illustrated in FIG. 5, the distribution of the wiring density can be expressed in a contour state. In FIG. 5, the region d1 shows a region with the wiring density of 0.84 or more, the region d2 shows a region with the wiring density of 0.67 or more and less than 0.84, the region d3 shows a region with the wiring density of 0.50 or more and less than 0.67, and the region d4 shows a region with the wiring density less than 0.50.

Supposing that the total number of wiring layers of the functional block 4 is 6, the relationship between the wiring density and the number of required wiring layers Lₙ is as follows. That is, if the wiring density is less than ⅙(≈0.17), the number of required wiring layers Lₙ is 1, if the number of wiring density is ⅙ or more and less than 2/6(≈0.33), the number of required wiring layers Lₙ is 2, if the wiring density is 2/6 or more and less than 3/6(=0.5), the number of required wiring layers Lₙ is 3, if the wiring density is 3/6 or more and less than 4/6(≈0.67), the number of required wiring layers Lₙ is 4, if the wiring density is 4/6 or more and less than ⅚ (≈0.84), the number of required wiring layers Lₙ is 5, and if the wiring density is larger than ⅚, the number of required wiring layers Lₙ is 6.

Therefore, in FIG. 5, the region dl has the number of required wiring layers Lₙ of 6, the region d2 has the number of required wiring layers Lₙ of 5, the region d3 has the number of required wiring layers Lₙ of 4, and the region d4 has the number of required wiring layers Lₙ of 3 or less. Here, the largest number of required wiring layers of the overlapping region d1 to the region d4 is set as the number of required wiring layers Lₙ of the small region 4a for each small region 4a.

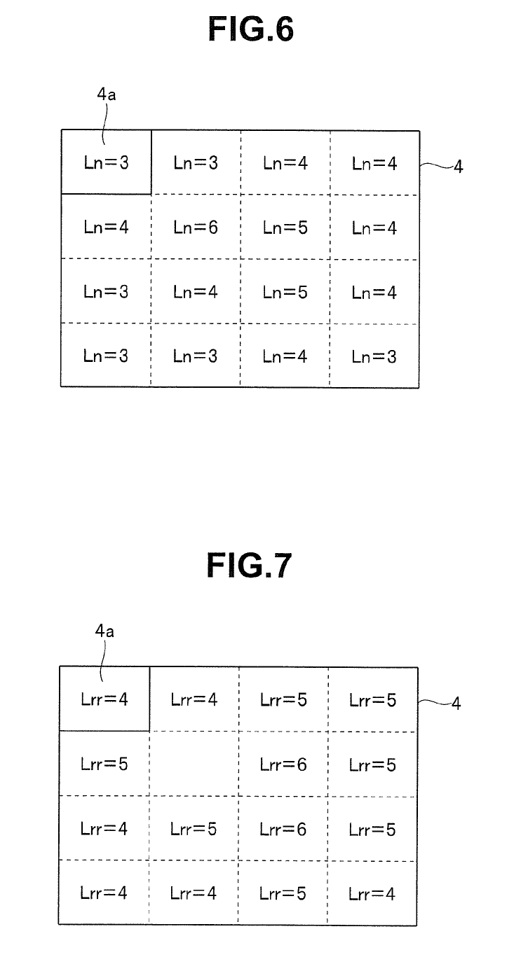

FIG. 6 illustrates the number of required wiring layers Lₙ of each small region 4a in the functional block 4 having the wiring density as in FIG. 5. FIG. 6 is a diagram for explaining the required wiring layers Lₙ of each small region 4a. That is, the number of required wiring layers Lₙ is 6 (layers) in the small region 4a₂₂ in which the region d1 is present, and the number of required wiring layers Lₙ is 5 (layers)in the small regions 4a₂₃ and 4a₃₃ where the region d1 is not present but the region d2 is present. Moreover, the number of required wiring layers Lₙ is 4 (layers) in the small regions 4a₁₃, 4a₁₄, 4a₂₁, 4a₂₄, 4a₃₂, 4a₃₄, and 4a₄₃ in which the region d1 and the region d2 are not present but the region d3 is present, and the number of required wiring layers Lₙ is 3 (layers) in the small regions 4a₁₁, 4a₁₂, 4a₃₁, 4a₄₁, 4a₄₂, and 4a₄₄ constituted by the region d4.

Subsequently, a wiring prohibited layer Lᵣᵣ is set for each small region 4a on the basis of the number of required wiring layers Lₙ (Step S26). Specifically, the layers in the number of required wiring layers Lₙ from the lowermost layer in the 6 wiring layers for each small region 4a are set as the layers allowed for wiring (low-order hierarchy wiring region) of the small region 4a, and the layer above the wiring allowed layers is set as the wiring prohibited layer Lₙ. Moreover, the wiring layers of the wiring prohibited layer Lᵣᵣ and above are set such that the wiring is not possible.

For example, the small region 4a₁₁ has the number of required wiring layers Lₙ of 3, and thus, the wiring layers from the lowermost layer to the third layer are set as the layers allowed for wiring. Therefore, the fourth layer is set as the wiring prohibited layer (Lᵣᵣ=4), and the wiring layers of the fourth layer and above (from the fourth layer to the sixth layer) are not allowed for wiring. Moreover, since the small region 4a₂₂ has the number of required wiring layers Lₙ of 6, for example, all the wiring layers from the lowermost layer to the sixth layer are set as layers allowed for wiring. In this case, since the total number of the wiring layers is 6, the wiring prohibited layer is not set.

As described above, as illustrated in FIG. 7, the wiring prohibited layer Lᵣᵣ is set for each small region 4a. FIG. 7 is a diagram for explaining the wiring prohibited layer Lᵣᵣ of each small region 4a. That is, the wiring prohibited layer Lᵣᵣ is not set for the small region 4a₂₂ having the number of required wiring layers Lₙ=6, while in the small regions 4a₂₃ and 4a₃₃ having the number of required wiring layers Lₙ=5, the wiring prohibited layer Lᵣᵣ=6. Moreover, in the small regions 4a₁₃, 4a₁₄, 4a₂₁, 4a₂₄, 4a₃₂, 4a₃₄, and 4a₄₃ having the number of required wiring layers Lₙ=4, the wiring prohibited layer Lᵣᵣ=5, and in the small regions 4a₁₁, 4a₁₂, 4a₃₁, 4a₄₁, 4a₄₂, and 4a₄₄ having the number of required wiring layers Lₙ=3, the wiring prohibited layer Lᵣᵣ=4.

Lastly, actual wiring is installed considering the wiring prohibited layer Lᵣᵣ set for each small region 4a (Step S27).

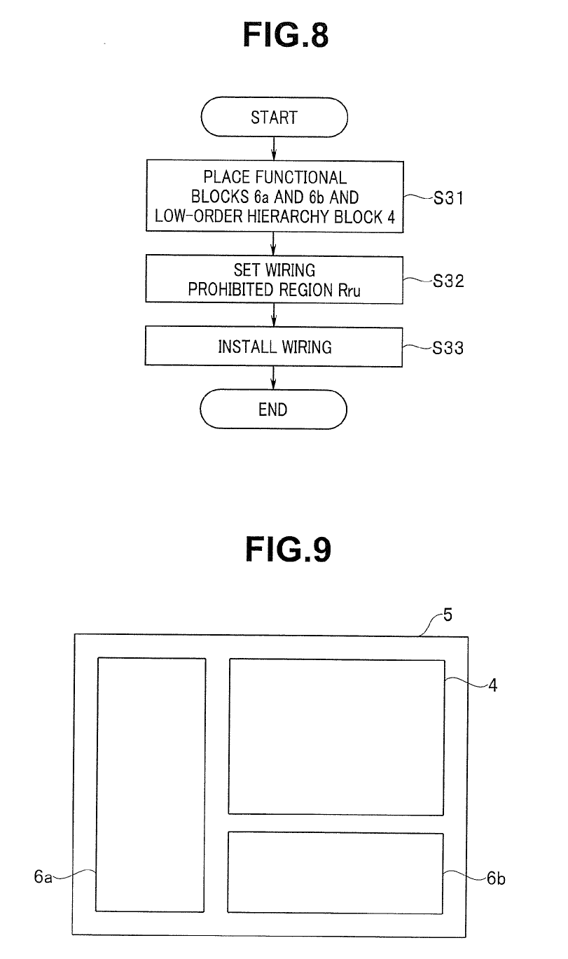

Subsequently, a detailed procedure of designing of the high-order hierarchy at Step S3 executed after the above-described series of low-order hierarchy designing procedure is finished will be described by using FIG. 8. FIG. 8 is a flowchart for explaining the designing procedure of the high-order hierarchy of the semiconductor integrated circuit in this embodiment.

First, functional blocks 6a and 6b of the high-order hierarchy, which are second functional blocks, and the functional block 4 of the low-order hierarchy are placed on the chip 5 (Step S31). FIG. 9 illustrates a layout of the chip 5 on which the functional blocks 6a and 6b of the high-order hierarchy and the functional block 4 of the low-order hierarchy are placed. As illustrated in FIG. 9, the one or more functional blocks 6a and 6b of the high-order hierarchy are placed with a certain space ensured so as not to overlap the functional block 4 of the low-order hierarchy.

Subsequently, a wiring prohibited region Rᵣᵤ is set for the wiring between the functional blocks of the high-order hierarchy (Step S32). In the prior-art designing device for a semiconductor integrated circuit, all the regions of the functional block 4 of the low-order hierarchy are set as the wiring prohibited regions Rᵣᵤ, but in this embodiment, only the wiring regions where wiring might be placed in the functional block 4 of the low-order hierarchy (the wiring layers in the number of required wiring layers Lₙ from the lowermost layer in the 6 wiring layers provided in each small region 4a) are set as the wiring prohibited regions Rᵣᵤ. That is, the wiring layer where the wiring is not placed in each small region 4a in the functional block 4 of the low-order hierarchy is set as a region that can be used for wiring between the functional blocks of high-order hierarchy.

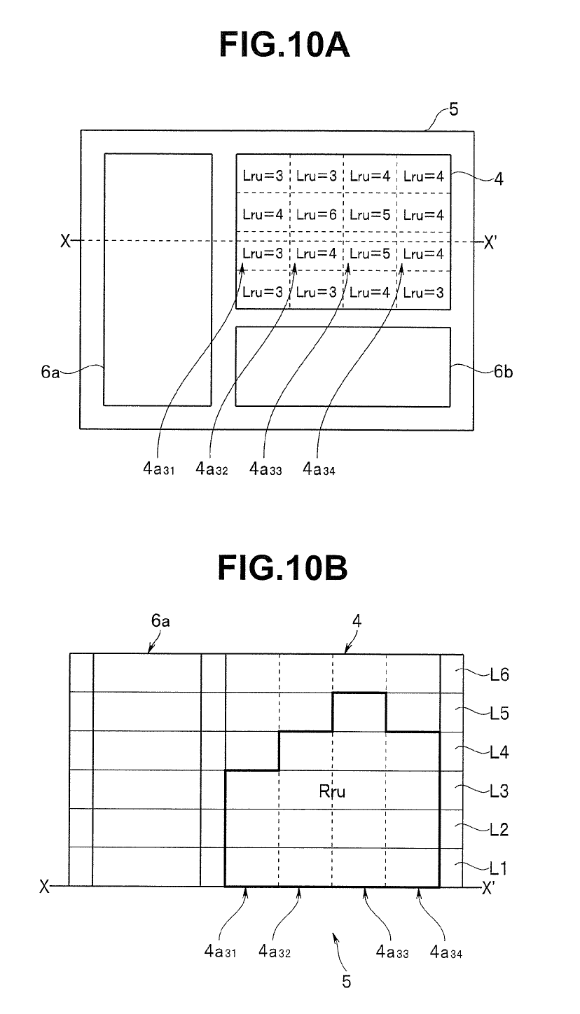

The wiring prohibited region Rᵣᵤ in the functional block 4 of the low-order hierarchy will be specifically described by using FIGS. 10A and 10B. FIGS. 10A and 10B are diagrams for explaining the wiring prohibited region Rᵣᵤ set for the functional block 4 of the low-order hierarchy during the high-order hierarchy wiring, in which FIG. 10A shows a plan view of the chip 5 and FIG. 10B shows a sectional view of the chip 5 at x-x′ in FIG. 10A. The sectional view in FIG. 10B shows only the layers of the wiring layer and above, and wiring layers L1, L2, L3, L4, L5, and L6 are sequentially laminated and formed from the x-x′ axis toward the upper side in the figure.

First, a layer where placement of the wiring which connects the functional blocks 6 of the high-order hierarchy is prohibited is acquired for each of the small regions 4a constituting the functional block 4 of the low-order hierarchy. Since a wiring prohibited layer Lᵣᵤ of each small region 4a is equal to the number of required wiring layers Lₙ illustrated in FIG. 6 as described above, the wiring prohibited layer Lᵣᵤ in each small region 4a is as illustrated in FIG. 10A.

That is, the small region 4a₂₂ becomes the wiring prohibited layer Lᵣᵤ=6, the small regions 4a₂₃ and 4a₃₃ become the wiring prohibited layers Lᵣᵤ=5. Moreover, the small regions 4a₁₃, 4a₁₄, 4a₂₁, 4a₂₄, 4a₃₂, 4a₃₄, and 4a₄₃ become the wiring prohibited layers Lᵣᵤ=4 (layers), and the small regions 4a₁₁, 4a₁₂, 4a₃₁, 4a₄₁, 4a₄₂, and 4a₄₄ become the wiring prohibited layers Lᵣᵤ=3.

The wiring prohibited region Rᵣᵤ is a region combining a substantially columnar region from the first wiring layer (L1) to the respective wiring prohibited layer Lᵣᵤ in each small region 4a. For example, the sectional shape of the wiring prohibited layer Rᵣᵤ on the x-x′ line passing the small regions 4a₃₁, 4a₃₂, 4a₃₃, and 4a₃₄ is the shape combining a region from the first layer to the third layer of the small region 4a₃₁, a region from the first layer to the fourth layer of the small region 4a₃₂, a region from the first layer to the fifth layer of the small region 4a₃₃, and a region from the first layer to the fourth layer of the small region 4a₃₄, as illustrated in FIG. 10B.

Lastly, the wiring which connects the functional blocks of the high-order hierarchy to each other is placed so as not to pass the wiring prohibited region Rᵣᵤ set at Step S32 (Step S33). At this time, wirings are placed so as not to be in contact with existing wirings such as power-supply wirings other than the wiring prohibited region Rᵣᵤ on the functional block 4 of the low-order hierarchy.

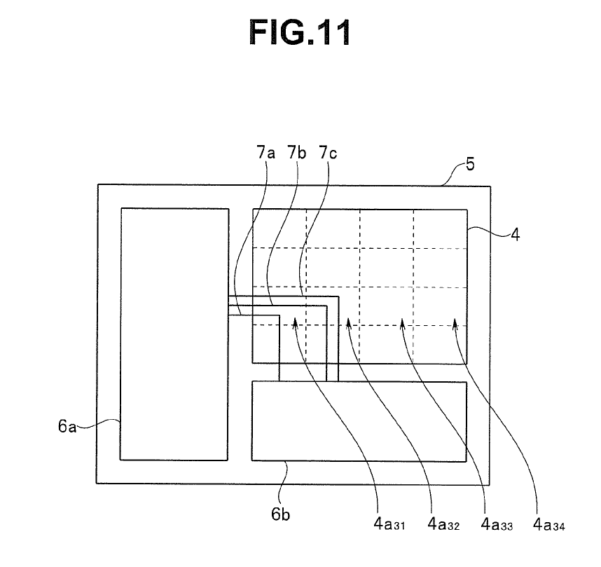

An example of a placement layout of wirings 7a to 7c which connect the functional blocks of the high-order hierarchy to each other will be described by using FIG. 11. FIG. 11 is a plan view for explaining an example of the placement layout of the wirings 7a to 7c which connect the functional blocks of the high-order hierarchy to each other.

As illustrated in FIG. 11, the wiring 7a, for example, is placed to extend from the functional block 6a of the high-order hierarchy toward the functional block 4 of the low-order hierarchy, changes the direction to the small region 4a₄₁ above the small region 4a₃₁ by 90 degrees, passes above the small region 4a₄₁ and reaches the functional block 6b. Also, the wirings 7b and 7c are placed to extend from the functional block 6a of the high-order hierarchy toward the functional block 4 of the low-order hierarchy, pass above the small region 4a₃₁ and extend to the small region 4a₃₂, change the direction toward the small region 4a₄₂ above the small region 4a₃₂ by 90 degrees, pass above the small region 4a₄₂ and reach the functional block 6b.

Here, the wiring prohibited region Rᵣᵤ in the small regions 4a₃₁, 4a₄₁, and 4a₄₂, is up to the third layer, and the wiring prohibited region Rᵣᵤ in the small region 4a₃₂ is up to the fourth layer. Therefore, the layers in the small regions 4a₃₁, 4a₄₁, and 4a₄₂ can be used for wiring between the functional blocks of the high-order hierarchy as long as the layer is the fourth layer or above, and the layers in the small region 4a₃₂ can be used for wiring between the functional blocks of the high-order hierarchy as long as the layer is the fifth layer or above.

Therefore, short-circuit with the wiring placed in the functional block 4 of the low-order hierarchy can be prevented by placing the wiring 7a in the wiring layer on the fourth layer or above in the small regions 4a₃₁ and 4a₄₁. Similarly, short-circuit with the wiring placed in the functional block 4 of the low-order hierarchy can be prevented by placing the wirings 7b and 7c in the wiring layer of the fourth layer or above in the small regions 4a₃₁ and 4a₄₂ and in the wiring layer of the fifth layer or above in the small region 4a₃₂.

As described above, in this embodiment, the functional block 4 of the low-order hierarchy is divided into the small regions 4a, the number of layers required for wiring in each of the small regions 4a (the number of required wiring layers Lₙ) is calculated, the layers above them are set as the wiring prohibited regions and the wiring are placed in the semiconductor integrated circuit having a plurality of wiring layers. Therefore, when the wiring between the functional blocks of the high-order hierarchy are placed, the wiring layers above the functional block 4 of the low-order hierarchy set as the wiring prohibited regions (for the wiring in the functional block 4 of the low-order hierarchy) and where the existing wiring are not installed can be used, there is no need to place the wiring between the functional blocks of the high-order hierarchy by using the peripheral region in order to avoid the whole region above the functional block 4 of the low-order hierarchy, and the chip area can be reduced.

Moreover, since it is not necessary to place the wiring in complicated paths in order to avoid the whole region above the functional block 4, a design period can be reduced, and also, the length of the wiring can be reduced, and the performances of the semiconductor integrated circuit can be improved. Furthermore, since the region where the wiring between the functional blocks of the high-order hierarchy can be placed is increased, an interval between the wirings can be sufficiently ensured, short-circuit between the wirings can be prevented, and a yield can be improved.

When the functional block 4 of the low-order hierarchy is to be divided into the small regions 4a, the shape of the small region 4a is not limited to the rectangular shape as illustrated in FIG. 4 but can have an arbitrary shape in accordance with the shape of the functional block 4. Moreover, the number of the small regions 4a is not limited to 16 but can be decided by considering the size of the functional block 4 or the like.

(Variation)

Subsequently, a variation of the above-described embodiment will be described. In the above-described embodiment, the functional block 4 of the low-order hierarchy is divided into the plurality of small regions 4a, each having a predetermined shape, the number of required wiring layers Lₙ is calculated for each small region 4a, the wiring prohibited layer Lᵣᵣ is set, and the wiring is placed. However, in the variation, the functional block 4 is not divided into the small regions 4a but the regions d1 to d4 determined from the distribution of the wiring density calculated by the temporary wiring are used as they are as the small regions, and the number of required wiring layers Lₙ and the wiring prohibited layer Lᵣᵣ are set.

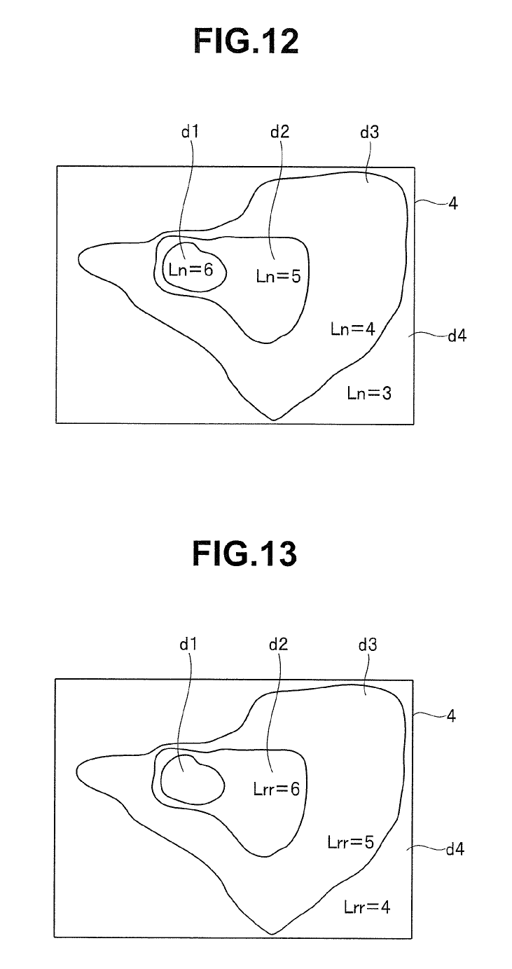

The settings of the small regions, the number of required wiring layers Lₙ and the wiring prohibited layer Lᵣᵣ in the variation will be described below by using FIGS. 12 and 13. FIG. 12 is a diagram for explaining an example of the distribution of the wiring density in the functional block 4 and the number of required wiring layers Lₙ in each of the regions d1 to d4. Also, FIG. 13 is a diagram for explaining the wiring prohibited layer Lᵣᵣ in each of the regions d1 to d4 illustrated in FIG. 12. The distribution shape of the wiring density of the functional block 4 illustrated in FIG. 12 is assumed to be equal to the distribution shape illustrated in FIG. 5. Moreover, the method of dividing to the regions d1 to d4 is also equal to that in the above-described embodiment. That is, a region with the wiring density of 0.84 or more is the region d1, a region with the wiring density of 0.67 or more and less than 0.84 is the region d2, a region with the wiring density of 0.50 or more and less than 0.67 is the region d3, and a region with the wiring density less than 0.50 is the region d4.

The relationship between the number of required wiring layers Lₙ and the wiring density described in the above-described embodiment will be used. As illustrated in FIG. 12, the number of required wiring layers Lₙ of the region d1 is 6 (layers), the number of required wiring layers Lₙ of the region d2 is 5 (layers), the number of required wiring layers Lₙ of the region d3 is 4 (layers), and the number of required wiring layers Lₙ of the region d4 is 3 (layers).

Since the wiring layers located above the number of required wiring layers Lₙ are set as wiring prohibited, the wiring prohibited layer Lᵣᵣ is set for each of the regions d1 to d4. That is, as illustrated in FIG. 13, the wiring prohibited layer Lᵣᵣ of the region d1 is not set, the wiring prohibited layer Lᵣᵣ of the region d2 is 6 (layers), the wiring prohibited layer Lᵣᵣ of the region d3 is 5 (layers), and the wiring prohibited layer Lᵣᵣ of the region d4 is 4 (layers).

Therefore, the wiring layers of the sixth layer of the region d2, the fifth and sixth layers of the region d3, and the fourth to sixth layers of the region d4 are set as the wiring prohibited regions in wiring of the functional block 4 of the low-order hierarchy, and actual wiring is placed so as not to pass these regions. The wirings between the functional blocks of the high-order hierarchy are placed similarly to the above-described embodiment by using the wiring layers above the functional block 4 of the low-order hierarchy set as the wiring prohibited regions (for the wiring in the functional block 4 of the low-order hierarchy) and where the existing wiring is not installed.

As described above, the procedure of dividing the functional block 4 into the small regions 4a can be omitted and the designing method can be simplified by calculating the wiring density distribution from the temporary wirings in the functional block 4 of the low-order hierarchy and by setting the wiring prohibited layer Lᵣᵣ and the wiring prohibited region by using the distribution shape. Moreover, since the wiring prohibited region in the wiring of the functional block 4 of the low-order hierarchy is reduced and the region capable of wiring between the functional blocks of the high-order hierarchy increases, further reduction of the chip area and reduction of the wire length are expected to contribute to further performance improvement and further improvement of the yield through prevention of short-circuit between wirings.

While certain embodiments have been described, these embodiments have been presented by way of example only, and are not intended to limit the scope of the inventions. Indeed, the novel methods and devices described herein may be embodied in a variety of other forms; furthermore, various omissions, substitutions and changes in the form of the methods and devices described herein may be made without departing from the spirit of the inventions. The accompanying claims and their equivalents are intended to cover such forms or modifications as would fall within the scope and spirit of the inventions.

What is claimed is:

1. A designing device for a semiconductor integrated circuit comprising:
a low-order hierarchy wiring design portion configured to design a first wiring which connects a plurality of cells placed in a first functional block of a low-order hierarchy composed of the first functional block having wiring layers laminated in plural; and
a high-order hierarchy wiring design portion configured to design a second wiring which connects second functional blocks of a high-order hierarchy provided with a plurality of second functional blocks, each having the wiring layers laminated in plural, wherein
the low-order hierarchy wiring design portion is configured to divide the first functional block into a plurality of small regions, is configured to calculate a number of the wiring layers required for wiring in the functional block for each of the plurality of small regions and is configured to set the number as a number of low-order hierarchy wiring layers, the low-order hierarchy wiring design portion further configured to set the wiring layers in the number of the low-order hierarchy wiring layers from the wiring layer located on a lowermost part as a low-order hierarchy wiring region for each of the plurality of small regions, and the low-order hierarchy wiring design portion configured to place the first wiring in the low-order hierarchy wiring region; and
the high-order hierarchy wiring design portion configured to place the second wiring in the wiring layer of the first functional block other than the low-order hierarchy wiring region.

2. The designing device for a semiconductor integrated circuit of claim 1, wherein
the low-order hierarchy wiring design portion is configured to temporarily install the first wiring, the low-order hierarchy wiring design portion further configured to calculate a density distribution of the temporary wiring in the first functional block, and the low-order hierarchy wiring design portion further configured to calculate the number of low-order hierarchy wiring layers from the density distribution.

3. The designing device for a semiconductor integrated circuit of claim 2, wherein
the low-order hierarchy wiring design portion is further configured to calculate the number of low-order hierarchy wiring layers as an integer larger than a value obtained by multiplying a density of the temporary wiring and a number of wiring layers in the first functional block and closest to the value.

4. The designing device for a semiconductor integrated circuit of claim 3, wherein
the low-order hierarchy wiring design portion is further configured to calculate the number of low-order hierarchy wiring layers by using a highest density, if a region with different density of the temporary wiring is mixed in one of the small regions.

5. The designing device for a semiconductor integrated circuit of claim 2, wherein
the low-order hierarchy wiring design portion is configured to acquire the density of the temporary wiring by dividing a number of the temporary wirings by a number of wirings that can be theoretically placed.

6. The designing device for a semiconductor integrated circuit of claim 5, wherein
the low-order hierarchy wiring design portion is configured to acquire the number of low-order hierarchy wiring layers as an integer larger than a value obtained by multiplying a density of the temporary wiring and a number of wiring layers in the first functional block and closest to the value.

7. The designing device for a semiconductor integrated circuit of claim 1, wherein
the low-order hierarchy wiring design portion is configured to temporarily install the first wiring, is configured to calculate a density distribution of the temporary wiring in the first functional block, and is configured to divide the first functional block into a plurality of the small regions equal to a shape of the density distribution of the temporary wiring.

8. The designing device for a semiconductor integrated circuit of claim 7, wherein
the low-order hierarchy wiring design portion is configured to acquire the number of low-order hierarchy wiring layers as an integer larger than a value obtained by multiplying a density of the temporary wiring and a number of wiring layers in the first functional block and closest to the value.

9. The designing device for a semiconductor integrated circuit of claim 7, wherein
the low-order hierarchy wiring design portion is configured to acquire a density of the temporary wiring by dividing a number of the temporary wirings by a number of wirings that can be theoretically placed.

10. The designing device for a semiconductor integrated circuit of claim 9, wherein
the low-order hierarchy wiring design portion is configured to acquire the number of low-order hierarchy wiring layers as an integer larger than a value obtained by multiplying the density of the temporary wiring and a number of wiring layers in the first functional block and closest to the value.

11. A designing method for a semiconductor integrated circuit comprising:
dividing a first functional block having a plurality of laminated wiring layers into a plurality of small regions;
calculating a number of the wiring layers required for wiring in the functional block for each of the plurality of small regions and setting the number as a number of low-order hierarchy wiring layers;
setting the wiring layers in the number of the low-order hierarchy wiring layers from the wiring layer located on a lowermost part as a low-order hierarchy wiring region for each of the plurality of small regions;
placing first wiring which connects a plurality of cells placed in the first functional block to each other in the low-order hierarchy wiring region; and
placing second wiring which connects a plurality of second functional blocks, each having a plurality of the laminated wiring layers, to each other in the wiring layer of the first functional block other than the low-order hierarchy wiring region.

12. The designing method for a semiconductor integrated circuit of claim 11, wherein
the first wiring is temporarily installed before the first functional block is divided into a plurality of small regions, and after the first functional block is divided into a plurality of small regions, a density distribution of temporary wiring in the first functional block is calculated, and the number of low-order hierarchy wiring layers is calculated from the density distribution.

13. The designing method for a semiconductor integrated circuit of claim 12, wherein
the number of low-order hierarchy wiring layers is acquired as an integer larger than a value obtained by multiplying a density of the temporary wiring and a number of wiring layers in the first functional block and closest to the value.

14. The designing method for a semiconductor integrated circuit of claim 13, wherein
if a region with different density of the temporary wiring is mixed in one of the small regions, the number of low-order hierarchy wiring layers is calculated by using a highest density.

15. The designing method for a semiconductor integrated circuit of claim 12, wherein
a density of the temporary wiring is acquired by dividing a number of the temporary wirings by a number of wirings that can be theoretically placed.

16. The designing method for a semiconductor integrated circuit of claim 15, wherein
the number of low-order hierarchy wiring layers is acquired as an integer larger than a value obtained by multiplying a density of the temporary wiring and a number of wiring layers in the first functional block and closest to the value.

17. A designing method for a semiconductor integrated circuit comprising:
placing temporary wiring in a first functional block having a plurality of laminated wiring layers;
calculating density distribution of the temporary wiring in the first functional block;
dividing the first functional block into a plurality of small regions on a basis of the density distribution;
calculating a number of the wiring layers required for wiring in the functional block for each of the plurality of small regions and setting the number as a number of low-order hierarchy wiring layers;
setting the wiring layers in the number of the low-order hierarchy wiring layers from the wiring layer located on a lowermost part as a low-order hierarchy wiring region for each of the plurality of small regions;
placing first wiring which connects a plurality of cells placed in the first functional block to each other in the low-order hierarchy wiring region; and
placing second wiring which connects a plurality of second functional blocks, each having a plurality of the laminated wiring layers, to each other in the wiring layer of the first functional block other than the low-order hierarchy wiring region.

18. The designing method for a semiconductor integrated circuit of claim 17, wherein
the number of low-order hierarchy wiring layers is acquired as an integer larger than a value obtained by multiplying a density of the temporary wiring and a number of wiring layers in the first functional block and closest to the value.

19. The designing method for a semiconductor integrated circuit of claim 17, wherein
a density of the temporary wiring is acquired by dividing a number of the temporary wirings by a number of wirings that can be theoretically placed.

20. The designing method for a semiconductor integrated circuit of claim 19, wherein
the number of low-order hierarchy wiring layers is acquired as an integer larger than a value obtained by multiplying the density of the temporary wiring and the number of wiring layers in the first functional block and closest to the value.
